(19) United States
(12) Patent Application Publication
(10) Pub. No.: US 2015/0302107 A1
(43) Pub. Date: Oct. 22, 2015

(54) SELECTIVE DATA INPUT SYSTEM AND METHOD

(71) Applicant: Jung-eun BAE, (US)

(72) Inventor: Jung-eun Bae, Yongin-si (KR)

(21) Appl. No.: 14/440,352

(22) PCT Filed: Aug. 30, 2013
(86) PCT No.: PCT/KR2013/007812

§ 371 Date: May 2, 2015

(30) Foreign Application Priority Data
Dec. 14, 2012 (KR) 10-2012-0146502

(51) Int. Cl. G06F 17/30; G06F 3/0484

(52) U.S. Cl. CPC G06F 17/30905; G06F 17/30896; G06F 3/04847; G06F 3/04842

(57) ABSTRACT

The present invention relates to a selective electronic data input system and method. The present invention presents a selective data input system including: a content storage unit configured to include content to be provided to a program of the user terminal; and a content ID recognition unit configured to, when a data input area adapted to input data into the program is selected at the user terminal, recognize an identifier (ID) of the selected data input area. The management computer that has received a signal selecting the data input area from the user terminal recognizes the ID of the data input area, and transmits content corresponding to the recognized ID to the user terminal, thereby displaying the content in the program.

### TECHNICAL FIELD

The present invention relates to a selective electronic data input system and method. More particularly, the present invention relates to a selective electronic data input system and method that enable data input at an Internet website or a mobile website to be completed by providing data input content appropriate for each data input situation in the data input situation and then allowing the provided content to be selected, rather than using a conventional keyboard or touch screen keyboard.

### BACKGROUND ART

A method by which a user inputs data at an Internet website, a mobile website or the like generally uses a keyboard or a keyboard screen on a touch screen. Alternatively, there is a case where, when an e-mail address is input, an e-mail address can be input using the keyboard or keyboard screen on the touch screen and also the URL of an e-mail service provider attached behind the e-mail address is provided in advance such that it can be selected using a mouse or the like.

Although Web services using smart phones or computers have become part of our lives, most online services, such as web services, frequently require users to input data, and a method of inputting data uses a standardized keyboard or a standardized keyboard screen on a touch screen. However, a problem arises in that age groups who are not accustomed to the use of computers or humans who cannot easily use a keyboard or a keyboard screen are not provided with desired web services, etc. Furthermore, data should be input to mobile terminals having small screen sizes by means of provided keypads. Problems arise in that it is difficult to input data, error frequently occurs and various additional functions cannot be performed because the sizes of the keypads are small.

In order to overcome these problems, the invention of Korean Patent No. 10-0689525 (registration date: Feb. 23, 2007) entitled “Data Control Method via Mouse Function in Mobile Terminal” is disclosed.

The patented invention relates to a data control method via a mouse function in a mobile terminal and, more particularly, to a data control method via a mouse function in a mobile terminal in which various control functions, such as the selection, input and editing of data, are performed via a mouse function provided in the mobile terminal. In order to achieve this, a data control method via a mouse function in a mobile terminal includes the step of dragging and selecting specific letters/numbers from displayed letters/numbers via a mouse pointer in the mobile terminal; and the step of, when the specific letters/numbers are dragged and selected, performing the function of editing the letters/numbers dragged and selected via the mouse pointer.

Furthermore, a data control method via a mouse function in a mobile terminal includes the step of displaying a letter/number keyboard on the display unit of the mobile terminal; the step of selecting letters/numbers from the displayed letter/number keyboard via a mouse pointer; and the step of constructing a sentence while displaying the letters/numbers selected via the mouse pointer.

Furthermore, a data control method via a mouse function in a mobile terminal includes the step of selecting a specific area of an image via a mouse pointer in the mobile terminal; and the step of, when the specific area of the image has been selected, performing the function of editing the specific area of the selected image.

Furthermore, a data control method for an external device via the mouse function of a mobile terminal includes the step of, when the mobile terminal connects with the external device, switching to an external device mouse mode in which the mouse pointer of the mobile terminal controls the data of the external device; and the step of controlling the data of the external device in response to the operation of the mouse pointer of the mobile terminal in the mouse mode of the external device.

Although the patented invention is intended to facilitate data input in a small size mobile terminal, the mobile terminal should be provided with a mouse function, the patented invention corresponds to a data input method intended to perform only the set functions of the mobile terminal, and the patented invention is an invention that is not related with user convenience that allows data input to be easily performed in a mobile web service environment.

Therefore, there is a need for an invention capable of facilitating input in wired/wireless web services, etc. without using a keyboard or the keyboard screen of a mobile device.

### PRECEDING TECHNOLOGY DOCUMENT

### Patent Document

(Patent document 1) Korean Patent No. 10-0689525 (registered on Feb. 23, 2007)

### DISCLOSURE

### Technical Problem

The present invention has been made keeping in mind the above problems occurring in the prior art, and an object of the present invention is to provide a selective data input system and method that, when data is input in order to use a web service at a terminal equipped with a wired/wireless communication means, enable data input to be facilitated through selecting content displayed on each data input portion, rather than using a conventional normalized keyboard or keyboard screen.

### Technical Solution

In order to accomplish the above object, in accordance with a first aspect of the present invention, there is provided a selective data input system, including: at least one user terminal including a wired/wireless communication means; a management computer including a web program storage unit configured to store a web program that is provided when the user terminal establishes a connection using the communication means, a content ID processing unit configured to receive a mouse or touch input signal input to a web program provided in the user terminal and recognize and process the content ID of the input signal, and a data processing unit configured to search for content recognized by the content ID processing unit and transmit the retrieved content to the user terminal; a content DB configured to store content included in the management computer or to be provided to the user terminal that has established a communication connection; and an input information DB configured to store information selected and input from the web program of the user terminal.

Furthermore, in accordance with a second aspect of the present invention, there is provided a selective data input method, including: connecting, by at least one user terminal, to a management computer using a communication means; providing, by the management computer, a web program to the connecting user terminal; inputting a mouse or touch input signal into the data input area of the web program displayed on the user terminal and then transmitting the input signal to the management computer; recognizing, by the management computer, the ID of the input signal transmitted from the user terminal; searching, by the management computer, for content having the corresponding ID in the content DB based on the recognized ID; transmitting the content, retrieved by the management computer, to the user terminal, so that the content is displayed in the web program; when a signal selecting content displayed in the web program of the user terminal is input, displaying the selected content in the data area repeating, when the signal selecting the content displayed in the web program of the user terminal is input, displaying the selected content in the data area; completing, by the user terminal, data input, and transmitting, by the user terminal, the completed data to the management computer; and storing, by the management computer, the data transmitted from the user terminal.

### Advantageous Effects

According to the selective data input system and method of the present invention, an advantage arises in that, when data is input in order to use a web service at a terminal equipped with a wired/wireless communication means, data input can be facilitated through selecting content displayed on each data input portion, rather than using a conventional normalized keyboard or keyboard screen.

### DESCRIPTION OF DRAWINGS

FIG. 1 is a schematic configuration diagram of an embodiment of a selective data input system according to the present invention;

FIG. 2 is a schematic configuration diagram of an embodiment of a management computer, i.e., a principal part of the embodiment of the present invention;

FIG. 3 is a configuration diagram of the membership subscription screen of a website that is used to illustrate the embodiment of the present invention;

FIG. 4 is a diagram illustrating an example of selectively inputting data into a name input area on the membership subscription screen of FIG. 3;

FIG. 5 is a diagram illustrating an example of selectively inputting data into an address input area on the membership subscription screen of FIG. 3;

FIG. 6 is a diagram illustrating another example of selectively inputting data into an address input area on the membership subscription screen of FIG. 3;

FIG. 7 is a diagram illustrating an example of selectively inputting data into a telephone number input area on the membership subscription screen of FIG. 3;

FIG. 8 is a diagram illustrating an example of selectively inputting data into an e-mail address input area on the membership subscription screen of FIG. 3;

FIG. 9 is a diagram illustrating an example of selectively inputting data into an ID input area on the membership subscription screen of FIG. 3;

FIG. 10 is a diagram illustrating an example of selectively inputting data into a password input area on the membership subscription screen of FIG. 3;

FIG. 11 is a flowchart illustrating an embodiment of a selective data input method according to the present invention; and

FIG. 12 is a flowchart illustrating another embodiment of a selective data input method of the present invention.

### DESCRIPTION OF REFERENCE SYMBOLS

100: user terminal

200: management computer

310: content DB

320: input information DB

### BEST MODE

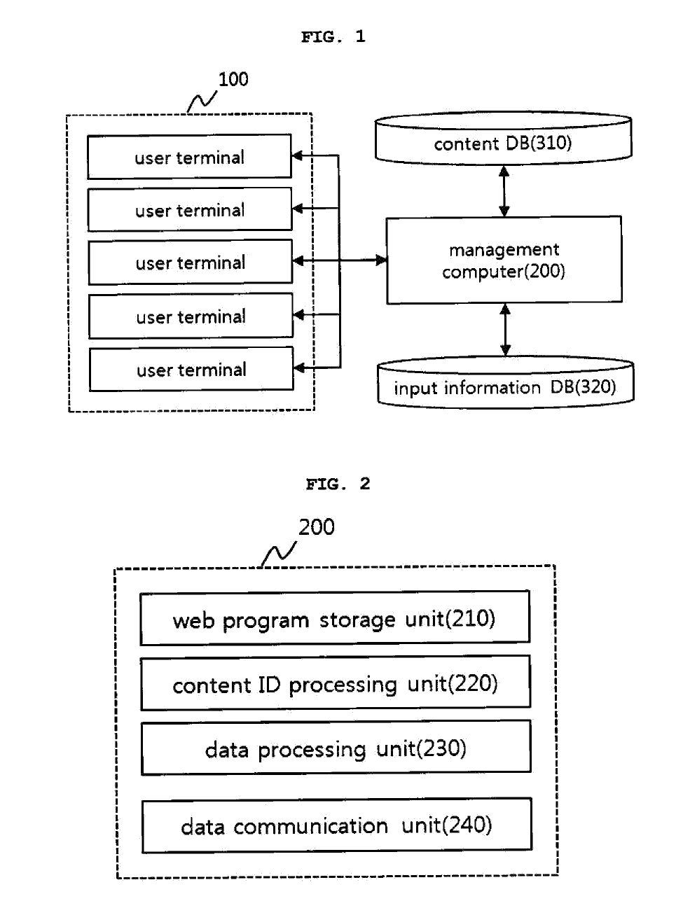

Embodiments of the present invention are described in detail below with reference to the accompanying diagrams. FIG. 1 is a schematic configuration diagram of an embodiment of a selective data input system according to the present invention. FIG. 2 is a schematic configuration diagram of an embodiment of a management computer, i.e., a principal part of the embodiment of the present invention. As illustrated in FIGS. 1 and 2, the selective data input system of the present invention includes: at least one user terminal 100 including a wired/wireless communication means; a management computer 200 including a web program storage unit 210 configured to store a web program that is provided when the user terminal 100 establishes a connection using the communication means, a content ID processing unit 220 configured to receive a mouse or touch input signal input to a web program provided in the user terminal 100 and recognize and process the content ID of the input signal, a data processing unit 230 configured to search for content recognized by the content ID processing unit 220 and transmit the retrieved content to the user terminal 100, and a data communication unit 240 configured to perform data transmission and reception with the user terminal 100; a content DB 310 configured to store content included in the management computer 200 or to be provided to the user terminal 100 that has established a communication connection; and an input information DB 320 configured to store information selected and input from the web program of the user terminal 100.

When the at least one user terminal 100 connects with the management computer 200 using the communication means, the management computer 200 transmits a web program, for example, a website, stored in the web program storage unit 210, to the connected user terminal 100, thus allowing the web program to be displayed on the user terminal 100. To input data into any one data input area of the web program displayed on the user terminal 100, a user inputs a click or touch signal using a mouse or a touch screen. The signal input into the data input area is transmitted to the management computer 200, and the content ID processing unit 220 of the management computer 200 recognizes the ID of the received input signal. The ID is the ID of the type (a name, an address, a telephone number, or the like) of data to be input into, for example, the data input area of the membership subscription screen of the web program correspond. The data processing unit 230 searches for content corresponding to the ID in the content DB 310 based on the ID recognized by the content ID processing unit 220, and transmits the retrieved content to the user terminal 100 via the data communication unit 240. The user terminal 100 displays the content, transmitted from the management computer 200, near the selected data input area of the web program. The content that is displayed may be Korean alphabet keyboard content if the selected data input area is a name input area, number keyboard content if the selected data input area is a telephone number input area, and combined alphabet and number content if the selected data input area is an e-mail address input area. A user selects corresponding content from the content displayed near the data input area using a mouse or via touch input, and the selected content is displayed in the data input area. Once data input has been completed by repeating the above-described operation, the user transmits the completed data to the management computer 200 by selecting the storage button of the web program, and the management computer 200 stores the data in association with the user identification information in the input information DB 320.

FIG. 3 is a configuration diagram of the membership subscription screen of a website that is used to illustrate the embodiment of the present invention. As illustrated in FIG. 3, an example of the membership subscription screen of the website that is provided and displayed when the user terminal 100 connects with the management computer 200 is illustrated. The membership subscription screen may include a name input field 1000, an address input field 2000, a telephone number input field 3000, an e-mail input field 4000, a user ID input field 5000, and a password input field 6000.

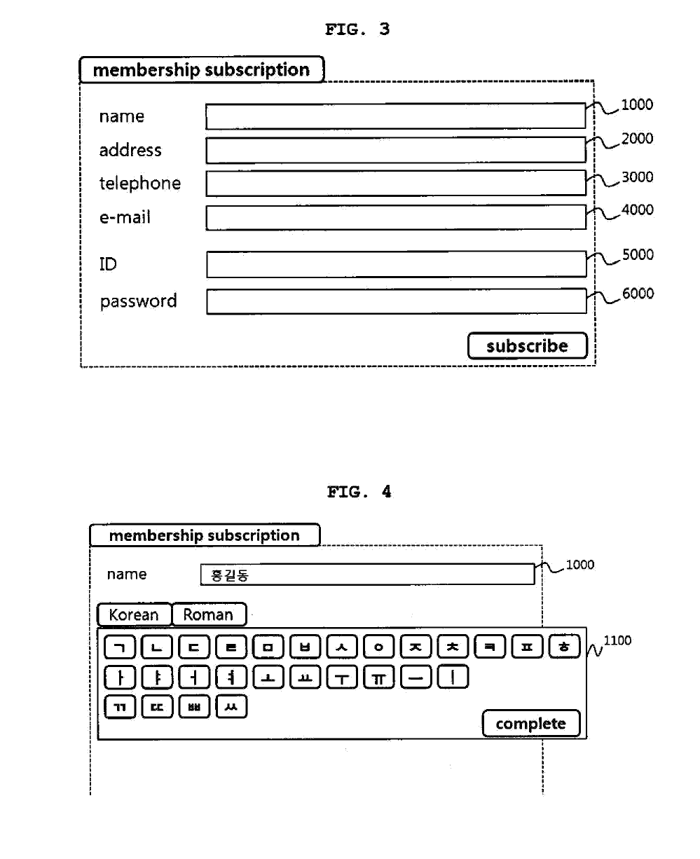

FIG. 4 is a diagram illustrating an example of selectively inputting data into a name input area on the membership subscription screen of FIG. 3. When the user clicks the mouse or makes a touch input on the name input field 1000, the name content screen 1100 into which a name may be input is displayed near the name input field 1000. When the user selects Korean alphabetical letters from the name content screen 1100 using the mouse or via touch input, the selected Korean alphabetical letters are input into the name input field 1000. To input a name in the Roman alphabet, the user may select a Roman alphabet button from the name content screen 1100 and then input the name.

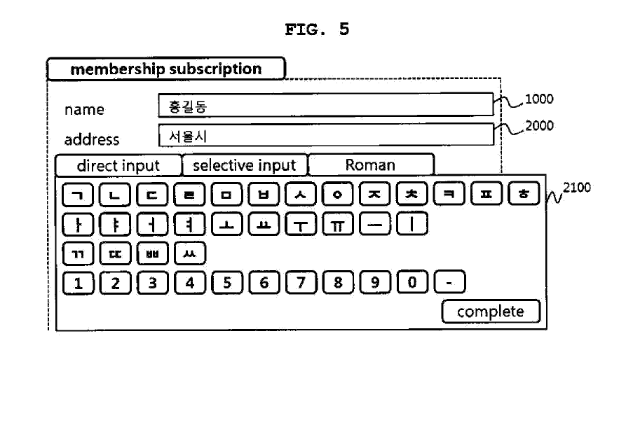

FIG. 5 is a diagram illustrating an example of selectively inputting data into an address input area on the membership subscription screen of FIG. 3. When a user clicks the mouse or makes a touch input on the address input field 2000, the address content screen 2100 into which an address may be input is displayed near the address input field 2000. When the user selects Korean alphabetical letters and one or more numbers using the mouse or via touch input on the address content screen 2100, the selected Korean alphabets and the numbers are input into the address input field 2000. To input an address in the Roman alphabet, the user may select a Roman alphabet button from the address content screen 2100 and input the address.

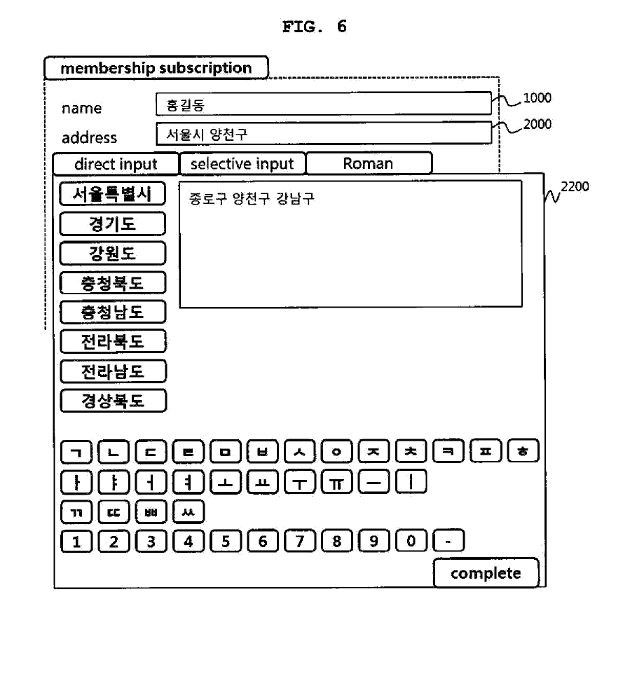

FIG. 6 is a diagram illustrating another example of selectively inputting data into an address input area on the membership subscription screen of FIG. 3. When the user selects a selective input button on the address content screen 2100, a screen is switched to the address selection content screen 2200 and thus the user may select and input an address using the mouse or via touch input.

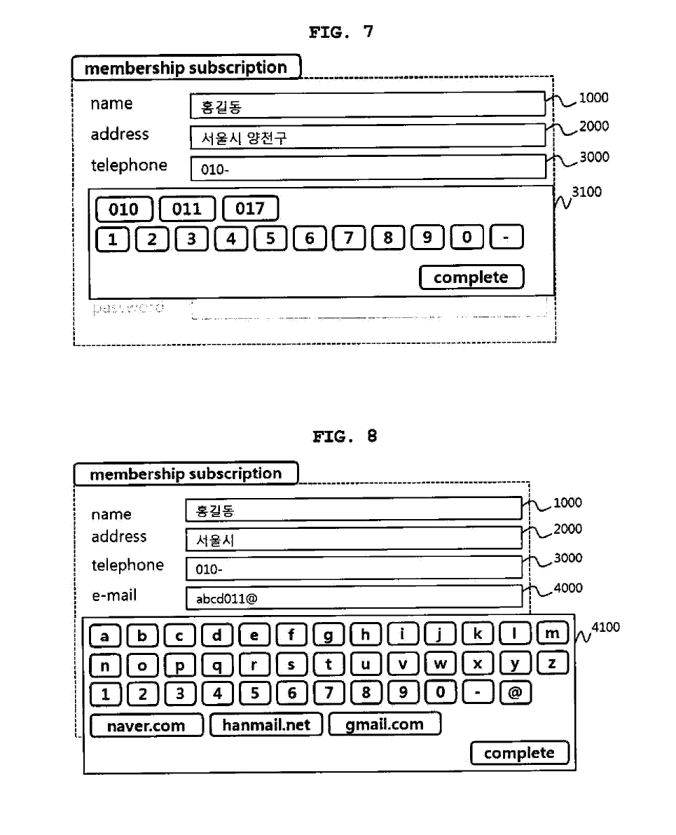

FIG. 7 is a diagram illustrating an example of selectively inputting data into a telephone number input area on the membership subscription screen of FIG. 3. When a user clicks the mouse or makes a touch input on the telephone number input field 3000, the telephone number content screen 3100 into which an address may be input is displayed near the telephone number input field 3000. When the user selects numbers from the telephone number content screen 3100 using the mouse or via touch input, the selected numbers are input into the telephone number input field 3000.

FIG. 8 is a diagram illustrating an example of selectively inputting data into an e-mail address input area on the membership subscription screen of FIG. 3. When a user clicks the mouse or make a touch input on the e-mail address input field 4000, the e-mail content screen 4100 into which an address may be input is displayed near the e-mail address input field 4000. When the user selects Roman alphabetical letters and one or more numbers from the e-mail content screen 4100 using the mouse or via touch input, the selected e-mail address is input to the e-mail address input field 4000.

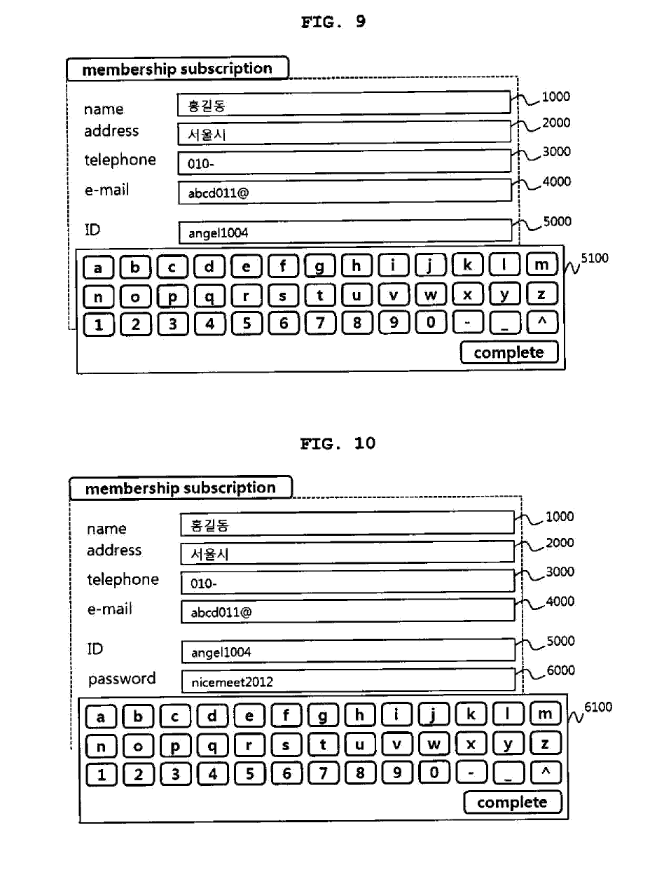

FIG. 9 is a diagram illustrating an example of selectively inputting data into an ID input area on the membership subscription screen of FIG. 3. When a user clicks the mouse or makes a touch input on the ID input field 5000, an ID content screen 5100 into an ID may be input is displayed near the ID input field 5000. When the user selects Roman alphabets and one or more numbers from the ID content screen 5100 using the mouse or via touch input, the selected user ID is input into the ID input field 5000.

FIG. 10 is a diagram illustrating an example of selectively inputting data into a password input area on the membership subscription screen of FIG. 3. When a user clicks the mouse or makes a touch input on the password input field 6000, a password content screen 6100 in which a password may be input is displayed near the password input field 6000. When the user selects an alphabetical letter, a number and/or a special character using the mouse or via touch input on the password content screen 6100, the selected user password is input into the password input field 6000.

As described above, in the selective data input system of the present invention, when the data input field is selected from the web program provided by the management computer 200, the management computer recognizes the ID of the selected data input field and displays a corresponding content screen, so that the user can easily input data only using the mouse or through the touch input on the displayed content screen.

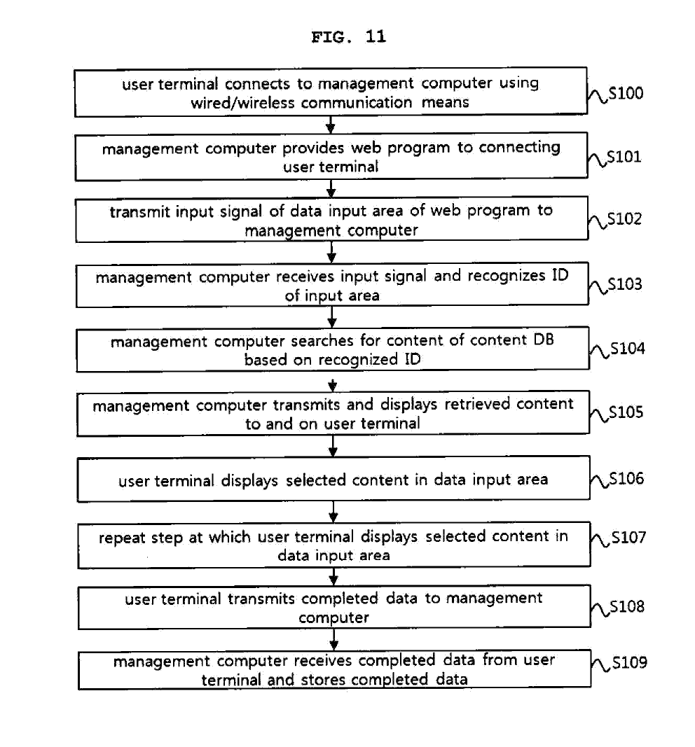

FIG. 11 is a flowchart illustrating an embodiment of a selective data input method according to the present invention. As illustrated in FIG. 11, the selective data input method of the present invention includes: step S100 of connecting, by the at least one user terminal, to the management computer using the communication means; step S101 of providing, by the management computer, a web program to the connecting user terminal; step S102 of inputting a mouse or touch input signal into the data input area of the web program displayed on the user terminal and then transmitting the input signal to the management computer, step S103 of recognizing, by the management computer, the ID of the input signal transmitted from the user terminal; step S104 of, searching, by the management computer, for content having the corresponding ID in the content DB based on the recognized ID; step S105 of transmitting the content, retrieved by the management computer, to the user terminal, so that the content is displayed in the web program; step S106 of, when a signal selecting content displayed in the web program of the user terminal is input, displaying the selected content in the data area; step S107 of repeating the step of, when the signal selecting the content displayed in the web program of the user terminal is input, displaying the selected content in the data area; step S108 of completing, by the user terminal, data input, and transmitting, by the user terminal, the completed data to the management computer; and step S109 of storing, by the management computer, the data transmitted from the user terminal.

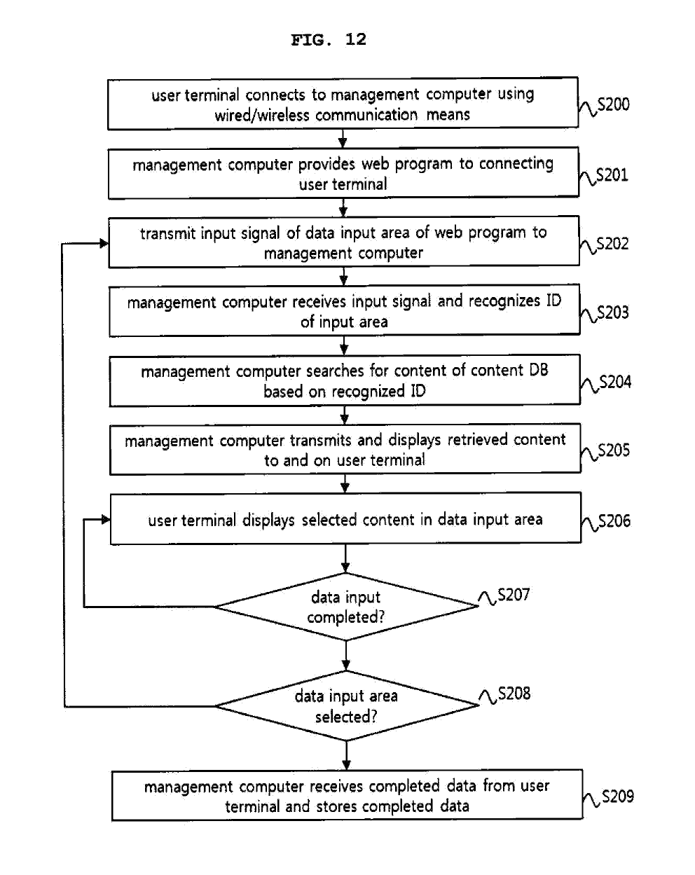

FIG. 12 is a flowchart illustrating another embodiment of a selective data input method of the present invention. As illustrated in FIG. 12, the selective data input method of the present invention includes: step S200 of connecting, by the at least one user terminal, to the management computer using the communication means; step S201 of providing, by the management computer, a web program to the connecting user terminal; step S202 of inputting a mouse or touch input signal into the data input area of the web program displayed on the user terminal and then transmitting the input signal to the management computer; step S203 of recognizing, by the management computer, the ID of the input signal transmitted from the user terminal; step S204 of searching, by the management computer, for content having the corresponding ID in the content DB based on the recognized ID; step S205 of transmitting the content, retrieved by the management computer, to the user terminal, so that the content is displayed in the web program; step S206 of, when a signal selecting content displayed in the web program of the user terminal is input, displaying the selected content on the data area; step S207 of determining, by the management computer, whether data input has been completed based on a content screen closing signal transmitted from the user terminal; step S208 of, if data input has not been completed at the user terminal, repeating step S206, and, if data input has been completed, determining, by the management computer, whether there is a signal selecting another data input area from the user terminal; and step S209 of, if there is a signal selecting another data input area, returning to step 202 and then performing its subsequent steps, and, if there is not a signal selecting another data input area, receiving and storing, by the management computer, the completed data transmitted from the user terminal.

The above-described embodiments of the present invention are merely part of various embodiments of the present invention. It will be apparent that various embodiments included in technical spirit in which data when an input area is selected in the wired/wireless web service of the present invention, corresponding content is displayed in a web program and data input is completed by selecting content by a user's mouse or touch input are included in the range of protection of the present invention.

Furthermore, although the web program provided by the management computer has been described as an example in the embodiments of the present invention, it will be apparent that the present invention is not limited thereto and the present invention is applied to an application program that is executed on a user terminal in the same manner.

1. A selective data input system comprising:
a content storage unit configured to include content to be provided to a program of the user terminal; and a content ID recognition unit configured to, when a data input area adapted to input data into the program is selected at the user terminal, recognize an identifier (ID) of the selected data input area;
wherein the management computer that has received a signal selecting the data input area from the user terminal recognizes the ID of the data input area, and transmits content corresponding to the recognized ID to the user terminal, thereby displaying the content in the program.

2. The selective data input system of claim 1, wherein the program is a web program that is provided by the management computer.

3. The selective data input system of claim 1, wherein the program is an application program that is executed on the user terminal.

4. The selective data input system of claim 1, wherein the content comprises at least one letter, number or character that is selectable using a mouse or via touch input at the user terminal.

5. The selective data input system of claim 1, wherein, when specific content of the content displayed in the program is selected using a mouse or via touch input, the selected content is displayed in the data input area.

6. The selective data input system of claim 5, wherein, when data input is completed by repeating the selection of content, the management computer receives the completed data and stores the completed data in association with the user information.

7. The selective data input system of claim 1, wherein, whenever the data input area is selected at the user terminal, the management computer transmits content corresponding to the selected data area, thereby displaying the content in the program of the user terminal.

8. A selective data input method comprising:
transmitting an input signal, selecting a data input area from a program displayed on at least one user terminal, to a management computer using a communication means;
recognizing, by the management computer, an ID of the input signal transmitted from the user terminal;
searching, by the management computer, for content having the corresponding ID based on the recognized ID, and transmitting, by the management computer, the retrieved content to the user terminal;
displaying, by the user terminal, the content transmitted from the management computer in the program;
when a signal selecting specific content of the content displayed in the program of the user terminal is input, displaying the selected content in the data input area;
repeating, when the signal selecting the content displayed in the web program of the user terminal is input, displaying the selected content in the data area;
completing, by the user terminal, data input, and transmitting, by the user terminal, the completed data to the management computer; and
storing, by the management computer, the data transmitted from the user terminal.

9. A selective data input method comprising:
transmitting an input signal, selecting a data input area from a program displayed on at least one user terminal, to a management computer using a communication means;
recognizing, by the management computer, an ID of the input signal transmitted from the user terminal;
searching, by the management computer, for content having the corresponding ID based on the recognized ID, and transmitting, by the management computer, the retrieved content to the user terminal;
displaying, by the user terminal, the content transmitted from the management computer in the program;
when a signal selecting specific content of the content displayed in the program of the user terminal is input, displaying the selected content in the data input area;
determining, by the management computer, whether data input has been completed based on a content screen closing signal transmitted from the user terminal;
if data input has not been completed, repeating, when a signal selecting specific content of the content displayed in the program of the user terminal is input, displaying the selected content in the data input area, and, if data input has been completed, determining, by the management computer, whether there is a signal selecting another data input area from the user terminal; and
if there is a signal selecting another data input area, returning to recognizing, by the management computer, the ID of the input signal transmitted from the user terminal, and then performing its subsequent steps, and, if there is not a signal selecting another data input area, receiving and storing, by the management computer, the completed data transmitted from the user terminal.

10. The selective data input method of claim 8, wherein the program is a web program that is provided by the management computer, or an application program that is downloaded by the user terminal from the management computer or an application program download computer and then installed.

11. The selective data input method of claim 9, wherein the program is a web program that is provided by the management computer, or an application program that is downloaded by the user terminal from the management computer or an application program download computer and then installed.
